(19) United States
(12) Patent Application Publication
(10) Pub. No.: US 2025/0258597 A1
(43) Pub. Date: Aug. 14, 2025

(54) INFORMATION PROCESSING METHOD AND APPARATUS, ELECTRONIC DEVICE, STORAGE MEDIUM AND PROGRAM PRODUCT

(71) Applicant: Beijing Zitiao Network Technology Co., Ltd., Beijing (CN)

(72) Inventors: Linxuan SHI, Beijing (CN); Dongyang ZHAO, Beijing (CN)

(21) Appl. No.: 19/044,288

(22) Filed: Feb. 3, 2025

(30) Foreign Application Priority Data
Feb. 8, 2024 (CN) 202410178181.0

(51) Int. Cl. G06F 3/0486; G06F 3/0481; G06F 40/177

(52) U.S. Cl. CPC G06F 3/0486; G06F 3/0481; G06F 40/177

(57) ABSTRACT

The invention provides an information processing method and apparatus, an electronic device, a storage medium and a program product. The method includes the following steps: acquiring a first operation on a first work item in a first system; displaying a first view, wherein the first view comprises a first tree view and a Gantt chart; wherein the first tree view is used for displaying the first work item and at least part of work item associated information of associated work items of the first work item, and the Gantt chart is used for displaying the first work item and scheduling information of the associated work items of the first work item.

### CROSS REFERENCE TO RELATED APPLICATIONS

This application is based on and claims the benefit of priority to the Chinese patent application No. 202410178181.0 filed on Feb. 8, 2024, which is hereby incorporated by reference in its entirety into the present application.

### TECHNICAL FIELD

The present disclosure relates to the field of computer technology, and in particular, to an information processing method and apparatus, an electronic device, a storage medium, and a program product.

### BACKGROUND

With the development of computers, users can use electronic devices to implement various functions. For example, users can interact with other users through electronic devices, and can also use electronic devices to promote work.

In some scenarios, a tool or platform based on data management (e.g., a project management system) can be built to accelerate project launch and avoid project risks by creating standardized business processes.

### SUMMARY

A first aspect of the present disclosure provides an information processing method, comprising:
obtaining (S101) a first operation for a first work item in a first system; and
displaying (S103) a first view, where the first view comprises a first tree view and a Gantt chart, the first tree view is configured to display at least part of work item association information of the first work item and an association work item of the first work item, and the Gantt chart is configured to display scheduling information for the first work item and the association work item of the first work item.

In some embodiments, in the first view:
the first tree view and the Gantt chart share a name list of the first work item and the association work item of the first work item; and
for a name item in the name list, work item association information corresponding to the name item in the first tree view and scheduling information corresponding to the name item in the Gantt chart are displayed in a same row.

In some embodiments, the association work item is determined based on a pre-configured first filter condition, and the method further comprises:
obtaining a second filter condition input by a user, and determining the scheduling information of the Gantt chart based on the first filter condition and the second filter condition.

In some embodiments, the second filter condition comprises a node display range of an association node between the first work item and the association work item; and

the method further comprises:
displaying a first Gantt bar corresponding to the first work item and the association work item in the Gantt chart; and
displaying the association node between the first work item and the association work item, and a second Gantt bar corresponding to the association node, wherein a length of the second Gantt bar is determined based on a start time and an end time of the association node.

In some embodiments, the method further comprises:
switching between displaying the first view and a second tree view in response to a view switching operation on the first work item
wherein view content of the second tree view is the same as view content of the first tree view in the first view.

In some embodiments, the method further comprises:
displaying a view switching entry in response to the first work item meeting a first preset condition, wherein the view switching entry is configured to implement the view switching operation.

In some embodiments, the second information comprises scheduling information, and that the first work item meets the first preset condition comprises:
the first work item being a first-type work item, wherein the first-type work item is capable of scheduling; or
the first work item being a second-type work item, and the first work item being configured to be capable of scheduling.

In some embodiments, the first work item is a second-type work item, and the first work item is configured to be capable of scheduling; after the displaying the first view, the method further comprises:
canceling displaying the view switching entry and switching the first view to the second tree view in response to modifying the first work item to be capable of scheduling.

In some embodiments, the view switch operation is performed by a first user, and the method further comprises:
determining, based on an operation permission of the first user on the first work item, whether the first view is displayed on a client corresponding to another user of the first work item.

In some embodiments, the first view comprises:
a name column region configured to display a name of the first work item and a name of the association work item of the first work item;
an information column region configured to display the at least part of the work item association information in the first tree view; and
a view region configured to display the scheduling information in the Gantt chart.

In some embodiments, the method further comprises:
increasing a display area of the information column region and reducing a display area of the view region, or reducing the display area of the information column region and increasing the display area of the view region in response to a drag-and-drop operation on the information column region.

In some embodiments, the method further comprises:
increasing display information in the information column region in response to a column insert operation on the information column region; or
reducing the display information in the information column region in response to a column delete operation on the information column region.

In some embodiments, the method further comprises:
configuring a display field in the information column region in response to a configure operation on the first view.

In some embodiments, the method further comprises:
displaying a scheduling operation entry in the view area, in response to at least one of the first work item, the association work item, or an association node between the first work item in the first view being capable of scheduling and not performing a scheduling operation; and
performing the scheduling operation on the at least one of the first work item, the association work item, or the association node between the first work item and the association work item in response to a Gantt bar draw operation based on the scheduling operation entry.

In some embodiments, the method further comprises:
displaying first prompt information, in response to at least one of the first work item, the association work item, or an association node between the first work item and the association work item in the first view being not capable of scheduling, wherein the first prompt information is configured to prompt that the at least one of the first work item, the association work item, or the association node between the first work item and the association work item is not configured to be capable of performing a scheduling operation.

A second aspect of the present disclosure provides an information processing apparatus, comprising:
an obtaining module configured to obtain a first operation on a first work item in a first system;
a display module configured to display a first view, wherein the first view comprises a first tree view and a Gantt chart; and
wherein the first tree view is used for displaying at least part of work item association information of the first work item and an association work item of the first work item, and the Gantt chart is used for displaying scheduling information of the first work item and the association work item of the first work item.

A third aspect of the present disclosure provides an electronic device, comprising a memory, a processor, and a computer program stored in the memory and executable on the processor, where the processor, when executing the program, implements the information processing method according to the first aspect.

A fourth aspect of the present disclosure provides a non-transitory computer-readable storage medium storing computer instructions, where the computer instructions are used for causing a computer to execute the information processing method according to the first aspect.

A fifth aspect of the present disclosure provides a computer program product comprising computer program instructions, where the computer program instructions, when executed on a computer, cause the computer to execute the information processing method according to the first aspect.

### BRIEF DESCRIPTION OF THE DRAWINGS

In order to more clearly illustrate the technical solutions in the present disclosure or in the related art, the drawings required in describing the embodiments or the related art will be briefly introduced below. Apparently, the drawings in the following description are merely embodiments of the present disclosure, and for those of ordinary skill in the art, other drawings may also be obtained from these drawings without any creative effort.

FIG. 1 is a schematic flowchart of an exemplary method according to embodiments of the present disclosure.

FIG. 2A is a schematic diagram of an exemplary page according to embodiments of the present disclosure.

FIG. 2B is a schematic diagram of an exemplary page according to embodiments of the present disclosure.

FIG. 2C is a schematic diagram of an exemplary page according to embodiments of the present disclosure.

FIG. 2D is a schematic diagram of an exemplary page according to embodiments of the present disclosure.

FIG. 2E is a schematic diagram of an exemplary page according to embodiments of the present disclosure.

FIG. 2F is a schematic diagram of an exemplary page according to embodiments of the present disclosure.

FIG. 2G is a schematic diagram of an exemplary page according to embodiments of the present disclosure.

FIG. 2H is a schematic diagram of an exemplary page according to embodiments of the present disclosure.

FIG. 3 is a schematic diagram of an exemplary apparatus according to embodiments of the present disclosure.

FIG. 4 is a schematic diagram of a hardware structure of an exemplary computer device according to embodiments of the present disclosure.

### DETAILED DESCRIPTION

In order to make the purpose, technical solutions, and advantages of the present disclosure clearer, the present disclosure will be further described in detail below with reference to the drawings and specific embodiments.

It should be noted that, unless otherwise defined, the technical or scientific terms used in the embodiments of the present disclosure shall have general meanings as understood by those of ordinary skill in the art to which the present disclosure belongs. “First”, “second”, and similar words used in the embodiments of the present disclosure do not indicate any order, number, or importance, but are only used to distinguish different components. Words such as “comprise” or “comprise” mean that an element or item preceding the term encompasses an element or item listed after the term and its equivalents, without excluding other elements or items. Words such as “connect” or “join” are not limited to a physical or mechanical connection, but may comprise an electrical connection, whether direct or indirect. “Up”, “down”, “left”, “right”, and the like are only used to indicate a relative positional relationship, and when an absolute position of a described object changes, the relative positional relationship may also change accordingly.

The current tools or platforms based on data management cannot meet users' usage requirements for displaying data information, resulting in a reduction in user experience.

In view of this, the present disclosure provides an information processing method and apparatus, an electronic device, a storage medium, and a program product.

Here, for the convenience of description, some concepts that may be involved in the present disclosure are introduced first.

Space is a basic unit for organizing collaboration, may be a management of a single project or a collection of a plurality of projects.

A work item is a work matter for a team to collaborate on, or may be a collection of matters for a project to disassemble. Work items may be classified into different types according to content, for example, a feature, an issue, a version, an iteration, a milestone, and the like.

A feature may refer to a software function required by a user to solve a certain problem/achieve a certain goal, which may help team members track specific details.

An issue refers to a business requirement that does not conform to an initial definition. For example, a pop-up window is not displayed.

A view is a fixed query dimension of a work item that is frequently concerned within a team and may also be referred to as a view dual special item. The view may have a plurality of types, such as a table, a list, a board, a Gantt chart, and a metric. The table may be an arrangement and combination of field information, and data is arranged in a cell mode. The Gantt chart may display a project schedule in a time dimension through a bar chart. The metric is a continuous quantitative process of performing data definition, collection, and analysis on software development projects, processes, and products. For example, requirement throughput, quality, cycle, and manpower estimation.

Source data is data for targeted measurement of an entire work item. For example, the source data may comprise work items, such as features, issues, versions, and iterations. The source data may comprise view data, such as a feature pool in progress, issues to be processed, and a view name customized by an individual. The source data may comprise a single instance, for example, a data range of a specific feature, issue, version, iteration, and the like.

Role refers to various types of roles involved in a project, and a project requires cooperation and support from different roles.

As shown in FIG. 1, an embodiment of the present disclosure provides an information processing method, comprising:
step S101 obtaining a first operation on a first work item in a first system.
step S103, displaying a first view, wherein the first view comprises a first tree view and a Gantt chart; wherein the first tree view is configured to display at least part of work item association information for the first work item and an association work item of the first work item, and the Gantt chart is configured to display scheduling information for the first work item and the association work item of the first work item.

As can be seen from the above, the information processing method and apparatus, the electronic device, the storage medium, and the program product provided by the present disclosure implement a display function of a first view for a first work item in a first system. In the first view, a first tree view and a Gantt chart for the first work item can be displayed concurrently. The first tree view can display at least part of work item association information about the first work item and an association work item of the first work item. The Gantt chart can display scheduling information about the same first work item and the association work item of the first work item. Therefore, the work item association information and the scheduling information about the first work item and the association work item of the first work item can be displayed concurrently in the first view, thereby fulfilling various viewing requirements of a user for the first work item and the association work item of the first work item, and improving user experience.

The first system may be, for example, a project management system, and the first work item is a work item in the project management system.

In this embodiment, in response to a user performing the first operation on the first work item in the first system, an execution subject of the information processing method (such as a server and/or a terminal device) may display the first view for the first work item on a first page of the first system. The first view comprises the first tree view and the Gantt chart, that is, the first tree view and the Gantt chart for the first work item are displayed concurrently in the first view, that is, the first tree view and the Gantt chart for the first work item are displayed concurrently on the first page.

The first tree view in the first view is configured to display at least part of work item association information for the first work item and an association work item of the first work item. The Gantt chart in the first view is configured to display scheduling information for the first work item and the association work item of the first work item. The first tree view and the Gantt chart are displayed for a same first work item and a same association work item of the first work item. Therefore, the work item association information and the scheduling information for the first work item and the association work item of the first work item can be displayed concurrently in the first view.

In this embodiment, the at least part of the work item association information may comprise relevant information for the first work item, and may also comprise relevant information for the association work item. All or part of information for the association work item may be displayed in different forms. The displayed at least part of work item association information may comprise information for the association work item itself, or may comprise statistical information obtained by performing statistics on the association work item. A display form of the at least part of work item association information may be set according to an actual application scenario, which is not limited in this embodiment.

The work item association information may comprise, but is not limited to, at least one of: basic information, node details, an operation record, note information, and the like.

In this embodiment, the association work item is a work item with an association relationship with the first work item. The association relationship may refer to a hierarchical relationship between the association work item and the first work item.

For example, the first work item is a feature-type work item A, and the association work item is an issue (bug) found in a process of solving a feature indicated by the work item A.

For example, the first work item is a feature-type work item A, and the association work item is a version iterated in a process of solving a feature indicated by the work item A.

For example, the first work item is a feature-type work item A, and the association work item is a sub-work item obtained by further disassembling the work item A.

It may be understood that the number of the first work item may be one or more, and the number of the association work item of the first work item may be one or more. Here, the above association work item may comprise one or more association work items.

In this embodiment, a display function of the first view for the first work item is implemented in the first system. The first tree view and the Gantt chart for the first work item can be displayed concurrently in the first view. The first tree view can display at least part of work item association information for the first work item and the association work item of the first work item. The Gantt chart can display the scheduling information for the same first work item and the association work item of the first work item. Therefore, the work item association information and the scheduling information for the first work item and the association work item of the first work item can be displayed concurrently in the first view, thereby fulfilling various viewing requirements of a user for the first work item and the association work item of the first work item, and improving user experience.

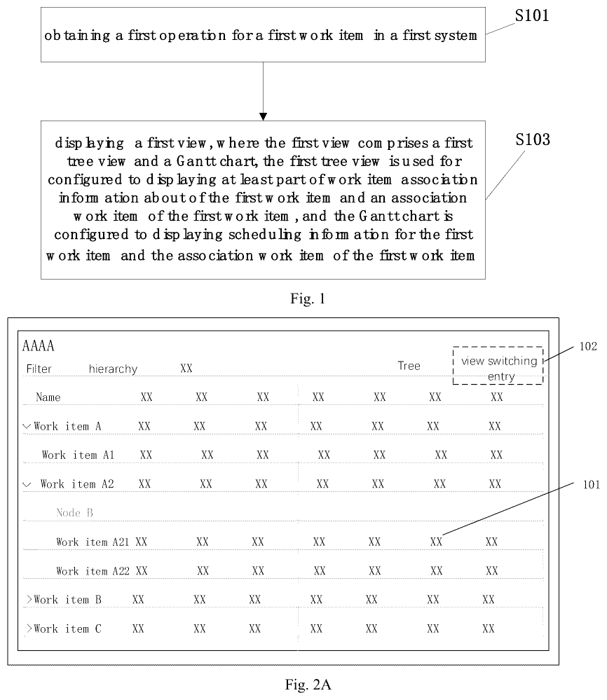

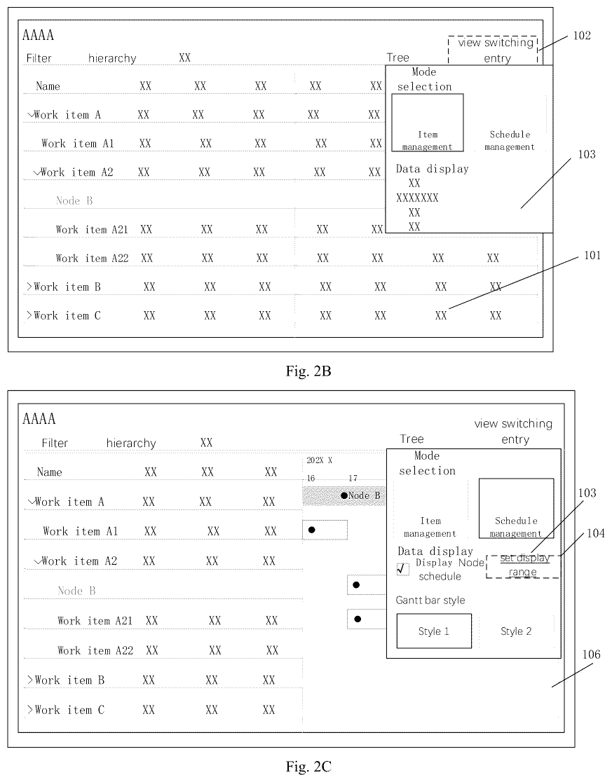

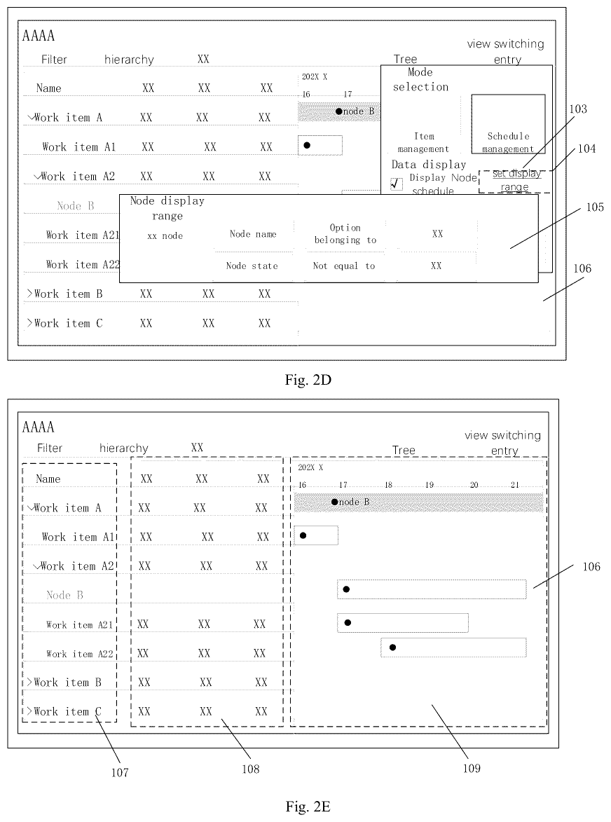

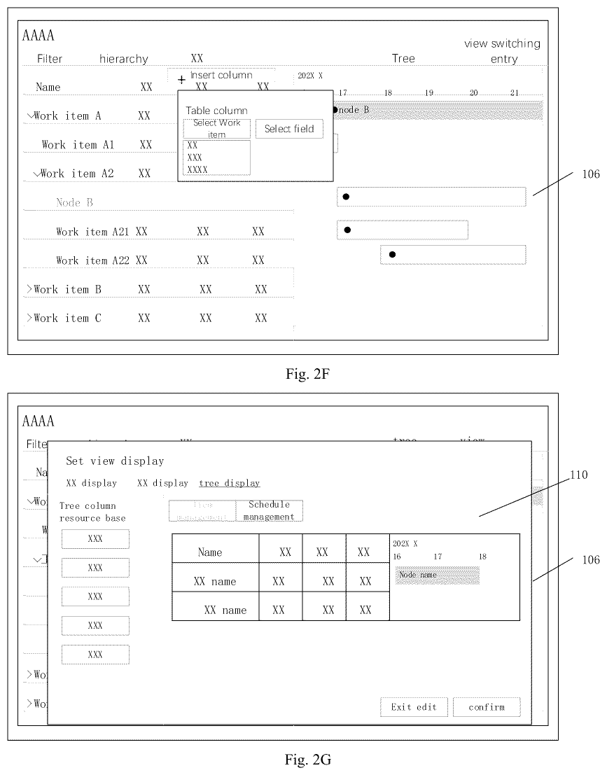

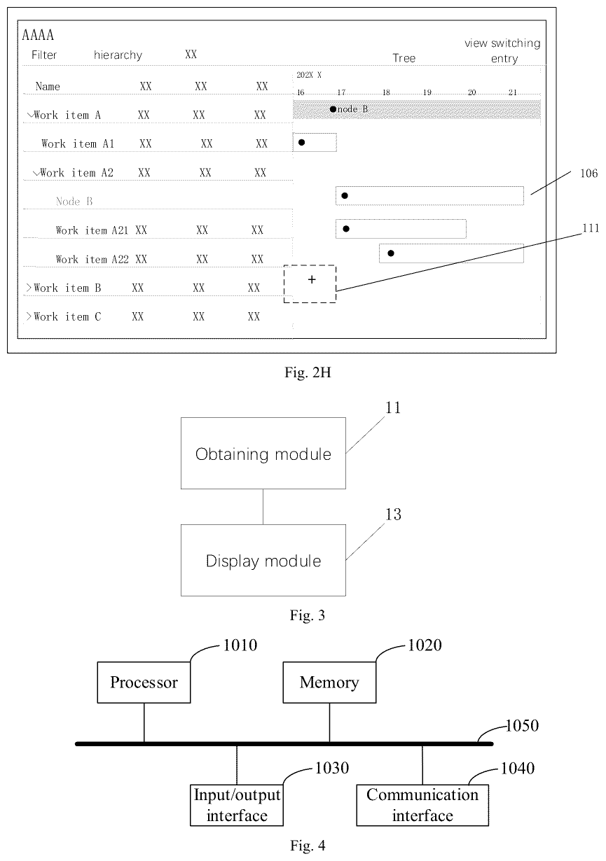

In some embodiments, as shown in FIG. 2E, in the first view: the first tree view comprises a name list of the first work item and the association work item of the first work item displayed in a name column region 107 and work item association information displayed in an information column region 108 in a table form, and the name list comprises name items of each first work item and the association work item of the first work item. The Gantt chart comprises a name list of the first work item and the association work item of the first work item displayed in the name column region 107 and scheduling information displayed in a view region 109 in a form of a Gantt bar.

As shown in FIG. 2E, in this embodiment, the first tree view and the Gantt chart share a name list of the first work item and the association work item of the first work item. Also, for a name item in the name list, work item association information corresponding to the name item in the first tree view and scheduling information corresponding to the name item in the Gantt chart are displayed in a same row. That is, for a same work item, the work item association information in the first tree view corresponds to the scheduling information in the Gantt chart, so that it is convenient for the user to view the relevant information for the work item in combination with the first tree view and the Gantt chart, and the user experience is improved.

In some embodiments, in response to the name list comprising an association node between the first work item and the association work item, since the association node does not comprise work item association information but scheduling information, no specific content is displayed in a display region corresponding to the association node in the first tree view, but corresponding scheduling information is displayed in the scheduling information for the Gantt chart.

In some embodiments, the association work item is determined based on a pre-configured first filter condition, that is, an information display range in the first tree view may be determined based on the first filter condition, that is, the at least part of work item association information displayed in the first tree view is determined based on the first filter condition.

In some embodiments, the association work item is determined based on a pre-configured first filter condition, and the method further comprises: obtaining a second filter condition input by a user and determining the scheduling information for the Gantt chart based on the first filter condition and the second filter condition.

In this embodiment, the association work item is determined based on the pre-configured first filter condition, that is, the hierarchical relationship between the first work item and the association work item may be set through the first filter condition, so as to determine display content of the first tree view.

In response to the first view being displayed based on the first operation, the user may input the second filter condition, and an execution subject of the information processing method may determine display information, that is, the scheduling information, in the Gantt chart based on the first filter condition corresponding to an original first tree view and the second filter condition input during the current first operation.

That is, in this embodiment, display data of the first view may be determined based on view data source data of the first tree view and the hierarchical relationship corresponding to the first work item, thereby fulfilling display requirements of the user for the view data.

In some embodiments, the second filter condition comprises a node display range of an association node between the first work item and the association work item. The association node between the first work item and the association work item may refer to a node to which the first work item and/or the association work item belong, that is, the first work item and/or the association work item are work items set in a section to which the association node belongs. Alternatively, the association node may also refer to a node having another relationship with the first work item and the association work item, which is not limited in this embodiment.

In response to the second filter condition comprising the node display range of the association node between the first work item and the association work item, the method further comprises:
Step S201: displaying a first Gantt bar corresponding to the first work item and the association work item in the Gantt chart; and.
Step S203: displaying the association node between the first work item and the association work item, and a second Gantt bar corresponding to the association node in the Gantt chart, wherein a length of the second Gantt bar is determined based on a start time and an end time of the association node.

In this embodiment, in response to the first view being displayed, not only the Gantt bar corresponding to the first work item and the association work item is displayed in the Gantt chart of the first view, but also the node set in the node display range of the association node between the first work item and the association work item defined in the second filter condition is additionally displayed. The node comprises the node to which the first work item and the association work item belong. Other nodes may also be additionally displayed according to the node display range set by the user, and the Gantt bar corresponding to the association node is displayed accordingly, so as to fulfill viewing requirement of the user for node related information.

In some embodiments, the node to which the first work item and the association work item belong may also be set to be displayed by default, and then the node set in the node display range is additionally displayed, and the Gantt bar corresponding to the association node is displayed accordingly, so as to fulfill the viewing requirement of the user for the node related information. This is not limited in this embodiment.

In this embodiment, in response to a first page of the first system only providing the display function of the first view, the first operation may be implemented through a trigger operation on a first control for implementing the display of the first view displayed on the first page. In response to the user triggering the first control, the first view may be displayed on the first page.

In some embodiments, in response to the first page of the first system not only providing the display function of the first view, but also providing display functions of other views, the display and switching of the first view and other views may be implemented through a view switching operation.

In some embodiments, the method further comprises: switching between displaying the first view and a second tree view in response to a view switching operation on the first work item; wherein view content of the second tree view is the same as view content of the first tree view in the first view.

In this embodiment, the first page not only provides the display of the first view, but also may only provide the display of the second tree view, wherein the view content of the second tree view is the same as the view content of the first tree view, that is, the view content of the second tree view is the same as the view content of the first tree view in which the Gantt chart is cancelled to be displayed.

In response to the display of a plurality of view forms comprising the first view and the second tree view being provided, the switching between the views may be implemented based on the view switching operation. Taking only providing the display functions of the first view and the second tree view and displaying the second tree view first by default as an example, before Step S101, the method further comprises: displaying the second tree view.

The first operation in Step S101 is the view switching operation, and the currently displayed second tree view may be switched to the first view based on the view switching operation.

In an embodiment, after the first view is displayed in Step S103, the currently displayed first view may also be switched to the second tree view based on the view switching operation, which is not limited in this embodiment.

In this embodiment, in response to the second tree view being displayed first on the first page, a plurality of items of work item association information may be displayed in the second tree view. In response to the first view being displayed based on the view switching operation, part of work item association information may be collapsed (that is, the first tree view is displayed) and the Gantt chart is displayed, so that more content information is displayed on the first page.

In some embodiments, the method further comprises: displaying a view switching entry in response to the first work item meeting a first preset condition, wherein the view switching entry is configured to implement the view switching operation

In this embodiment, in response to the first work item meeting a preset condition, the view switching operation may be performed on the first work item. Therefore, the view switching entry for implementing the view switching operation may be displayed on the first page of the first work item. In response to the first work item being not able to meet the preset condition, the view switching operation cannot be performed on the first work item. Therefore, the view switching entry for implementing the view switching operation cannot be displayed on the first page of the first work item.

The first preset condition may comprise a type of the first work item, configuration information for the first work item, etc., which is not limited in this embodiment.

In some embodiments, the first work item meeting the first preset condition comprises: the first work item being a first-type work item, wherein the first-type work item is capable of scheduling. That is, in response to the first work item being a first-type work item being capable of scheduling, the first view comprising the scheduling information may be displayed, and therefore the view switching entry for implementing the view switching operation can be displayed.

The first-type work item may be, for example, a node flow work item, that is, a process of a project is managed through nodes. A item of work may comprise a plurality of nodes, and a subsequent node is executed only after a previous node is completed, thereby implementing management of the process of the item of work. The node flow work item is capable of scheduling, and therefore a scheduling operation can be performed. The view switching operation may also be performed through the displayed view switching entry, to display the first view comprising the scheduling information.

In some embodiments, the first work item meeting the first preset condition comprises: the first work item being a second-type work item, and the first work item being configured to be capable of scheduling. That is, if the first work item being a second-type work item without the scheduling capability, in response to the first work item being configured with the scheduling capability through a configuration operation, the first view comprising the scheduling information may also be displayed for the work item, and therefore the view switching entry for implementing the view switching operation can be displayed.

The second-type work item may be, for example, a state flow work item, that is, a process of a project is managed through state information. For example, a work item may be managed through a state field, and in response to a previous stage of the work being completed, a management of the process of the item of work is implemented by changing the state information in the state field. In response to the state flow work item being configured with the scheduling capability, the scheduling operation may also be performed, the scheduling information based on the work item may also be displayed naturally, and the view switching operation may also be performed through the view switching entry, to display the first view comprising the scheduling information.

In response to the first work item being the state flow work item and being not configured to be capable of scheduling, the view switching entry is not displayed.

In some embodiments, in response to the first work item being a second-type work item, the first work item being configured to be capable of scheduling, and the configuration of the scheduling capability being switched from off to on, the view switching entry may be displayed.

In some embodiments, the first work item is a second-type work item, and the first work item is configured to be capable of scheduling, after the displaying the first view, the method further comprises: canceling displaying the view switching entry and switching the first view to the second tree view in response to modifying the first work item to be capable of scheduling.

That is, in this embodiment, in response to the first work item being a second-type work item, and the first work item being configured to be capable of scheduling, and the configuration of the scheduling capability being switched from on to off, the view switching entry is hidden. Also, the displayed first view comprising the scheduling information is modified to the second tree view that comprise no scheduling information.

In some embodiments, the view switching operation is performed by a first user, the method further comprises: determining, based on an operation permission of the first user on the first work item, whether the first view is displayed on a client corresponding to another user of the first work item.

In this embodiment, an effective range of the view switching operation may be determined based on an operation permission of a user performing the view switching operation.

In this embodiment, in response to the first user having the operation permission for the first work item, the first view may be displayed on a client of each user of the first work item. In response to the first user not having the operation permission for the first work item (for example, only having a viewing permission), the first view is displayed on a client of the first user, but is not displayed on a client of another user of the first work item.

In this way, it can be ensured that the view can meet an actual situation of a work item instance and can remain relatively stable. Specifically, different users may have different display preferences for the view, and the users may modify the view locally and display the view locally according to their own display preferences. However, since the view is oriented to all users in the work item, a default view in the work item is modified by a user with the operation permission, which can ensure that the view oriented to all users of the work item is relatively stable, and ensure smooth communication among users of the work item on the basis of the default view.

In some embodiments, the operation permission information for the first work item may be pre-configured. The operation permission information may authorize a target role to have the operation permission for the first work item, and then the target role is assigned to a corresponding user (for example, the first user), and the first user may have a corresponding permission of the target role.

The space administrator may select the target role from various roles of the work item (for example, an administrator, a creator, a collaborator product, a design).

In some embodiments, the target role in the operation permission information may comprise a collaborator. For a first user (for example, Zhang San) of a work item of feature A, if Zhang San is a collaborator, the first view obtained by Zhang San through a modification operation may not only be displayed at Zhang San, but also be displayed at other users (for example, Li Si and Wang Wu) of the work item of the feature A. If Zhang San is not a collaborator, the first view obtained by Zhang San through the modification operation is only displayed at Zhang San.

In some embodiments, the second tree view may comprise a name column region and an information column region. The name column region is configured to display a name of the first work item and a name of the association work item of the first work item, and the information column region is configured to display the at least part of the work item association information.

In some embodiments, the second view comprises the name column region, the information column region, and a view region. The name column region is configured to display a name of the first work item and a name of the association work item of the first work item. The information column region is configured to display the at least part of the work item association information in the first tree view. The view region is configured to display the scheduling information for the first work item and the first work item in the Gantt chart.

In some embodiments, in response to the second tree view being switched to the first view through the view switching operation, the display content of the name column region of the second tree view and the display content of the name column region of the first view may be the same, and/or, the display content of the information column region of the second tree view and the information column region of the first view may be the same.

In some embodiments, in response to the second tree view being switched to the first view through the view switching operation, the display content of the name column region of the second tree view and the name column region of the first view may be different. For example, in response to the second filter condition input by the user comprising the node display range of the association node between the first work item and the association work item, if the association node between the first work item and the association work item is added, a node name of the association node is displayed in the name column region of the first view. At this time, the display content of the name column region of the first view is different from the display content of the name column region of the second tree view.

In some embodiments, in response to the second tree view being switched to the first view through the view switching operation, the display content of the name column region of the second tree view and the name column region of the first view may be different. For example, display fields of the information column region of the second tree view and the information column region of the first view may be configured separately, so that the display fields of the information column region of the second tree view and the information column region of the first view are different, thereby fulfilling different viewing requirements of the user for the second tree view and the first view.

In some embodiments, regardless of whether the display content of the name column region and the information column region in the second tree view is the same as the display content of the name column region and the information column region in the first view, information about the first work item corresponding to the second tree view and the first view is the same, that is, the second tree view and the first view share a same view data source, but do not share column configurations.

In some embodiments, the method further comprises: increasing a display area of the information column region and reducing a display area of the view region, or reducing the display area of the information column region and increasing the display area of the view region in response to a drag-and-drop operation on the information column region.

In some embodiments, in response to the first view being displayed through the view switching operation, the display area of the information column region and the display area of the view region in the first view have a preset size or a preset ratio. For example, the information column region and the view region may each account for 50%.

In this embodiment, in response to the first view comprising the name column region, the information column region, and the view region, the name column region is usually frozen, that is, a size and/or a position of the name column region cannot be adjusted, and the name column region is usually displayed on a side of the first page. In order to facilitate the user to view the display content of the information column region and the view region, the user may drag the information column region to adjust the display area of the information column region and the display area of the view region. In response to the display area of the information column region being increased, the display area of the view region is reduced. In response to the display area of the information column region being reduced, the display area of the view region is increased, which is convenient for the user to view.

In some embodiments, in response to the user reducing the display area of the information column region through the drag-and-drop operation, the information column region may be completely hidden, which is not limited in this embodiment.

In some embodiments, the drag-and-drop operation on the information column region is only displayed on the client of the first user, but not displayed on the clients of other users of the first work item, which is not limited in this embodiment.

In some embodiments, the method further comprises: increasing display information in the information column region in response to a column insert operation on the information column region; or reducing the display information in the information column region in response to a column delete operation on the information column region.

In this embodiment, the display information in the information column region of the first view may be inserted and deleted directly in the first view, so that the display information in the information column region of the first view is different from the display information in the information column region of the second tree view, thereby fulfilling different viewing requirements of the user for data in two different views.

In some embodiments, the method further comprises: in response to a configuration operation on the first view, configuring a display field in the information column region.

In some embodiments, the display field in the information column region of the first view may be configured through the configuration operation on the first view, so as to determine the display content in the information column region of the first view.

In some embodiments, the method further comprises: displaying a scheduling operation entry in the view region, in response to at least one of the first work item, the association work item, or an association node between the first work item in the first view being capable of scheduling and not performing a scheduling operation; and performing the scheduling operation on the at least one of the first work item, the association work item, or the association node between the first work item and the association work item in response to a Gantt bar draw operation based on the scheduling operation entry.

In this embodiment, in response to each first work item, the association work item, or the association node has the scheduling capability but the scheduling operation being not currently performed, the scheduling operation entry may be displayed in the view region of the first view. For example, in response to the user hovering the mouse over a Gantt chart cell corresponding to each first work item, the association work item, or the association node, the display of the scheduling operation entry is triggered.

In some embodiments, in response to the scheduling operation entry being displayed, prompt information of “create a new schedule” may be displayed, and a time axis corresponding to the Gantt chart cell is highlighted.

In response to the user triggering the scheduling operation entry, a Gantt bar may be drawn to implement the scheduling operation on the first work item, the association work item, or the association node.

In some embodiments, the method further comprises: displaying first prompt information, in response to at least one of the first work item, the association work item, or an association node between the first work item and the association work item in the first view being not capable of scheduling, wherein the first prompt information is configured to prompt that the at least one of the first work item, the association work item, or the association node between the first work item and the association work item is not configured to be capable of performing a scheduling operation.

In this embodiment, for a work item instance such as the first work item, the association work item, or the association node without a scheduling capability, even if the user hovers the mouse over the Gantt chart cell corresponding to the first work item, the association work item, or the association node, the display of the scheduling operation entry is not triggered, and the first prompt information is also displayed at the same time. The first prompt information may be, for example, “[work item] scheduling capability is not currently enabled”, so that the user can be reminded that the first work item, the association work item, or the association node is not capable of scheduling, and the scheduling operation cannot be performed on the first work item, the association work item, or the association node.

Based on the same inventive concept, corresponding to any of the above embodiments, the present disclosure further provides another information processing method. In this embodiment, a first view is taken as an example of a table view corresponding to a function of item management, and a second view is taken as an example of a Gantt chart corresponding to schedule management, to illustrate the technical solutions of the present disclosure in detail.

As shown in FIG. 2A, a second tree view 101 of a first work item may be displayed on a first page. The first work item comprises a work item A, a work item B, and a work item C. An association work item of the first work item comprises a sub-work item of the work item A (a work item A1 and a work item A2) and a sub-work item of the work item A2 (a work item A21 and a work item A22). The second tree view 101 may further display relevant information of the first work item in a table form. In this embodiment, the display content of the second tree view 101 of the first work item may be determined based on a first filter condition. The first filter condition may be determined by triggering a hierarchical control on the first page to set a hierarchical relationship, which is not limited in this embodiment.

In response to the first work item meeting a first preset condition, for example, the first work item is a node flow work item, or the first work item is a state flow work item and is configured to have a scheduling capability, a view switching entry 102 is displayed on the first page. In response to the first work item not meeting the first preset condition, for example, the first work item is the state flow work item and is not configured to have the scheduling capability, the view switching entry 102 is not displayed.

In this embodiment, in response to the first work item being a state flow work item, and the first work item is configured to have a scheduling capability: in response to the configuration of the scheduling capability being switched from off to on, the view switching entry 102 may be displayed; in response to the configuration of the scheduling capability being switched from on to off, the view switching entry 102 is hidden. Also, the displayed first view comprising scheduling information is modified to the second tree view; in response to the configuration of the scheduling capability being switched from on to off and then to on, the view switching entry 102 may be displayed, but the first view that is closed during the schedule-off period is not be restored, and the second tree view is still displayed.

As shown in FIG. 2B, after the view switching entry 102 is displayed, in response to the user triggering the view switching entry 102, a mode selection window 103 is displayed. At this time, the second tree view 101 in an item management mode is displayed on the first page, and the current item management mode is displayed in the mode selection window 103 by default.

In the item management mode, the user may adjust a table attribute of the second tree view 101, such as a line height. In some embodiments, the user may also configure “hide parent data in response to a filtering result being empty”. After the configuration, in response to a data result being empty during filtering, the corresponding parent data is not displayed.

As shown in FIG. 2C, after the user triggers a schedule management mode in the mode selection window 103, the first view 106 based on the first work item is displayed on the first page. That is, the first tree view and the Gantt chart based on the first work item are displayed concurrently in the first view 106, and at least part of work item association information and the scheduling information of the first work item and the association work item of the first work item are displayed concurrently in the first view 106.

As shown in FIG. 2E, after the mode selection window 103 is closed, the first view 106 is displayed on the first page. The first view 106 comprises a name column region 107, an information column region 108, and a view region 109. The name column region 106 is configured to display the name of the first work item and the name of the association work item of the first work item. The information column region 108 is configured to display at least part of the work item association information in the first tree view. The view region 109 is configured to display the scheduling information for the first work item and the first work item in the Gantt chart.

In this embodiment, the user may expand or collapse a sub-level of each work item by triggering an expand/collapse control in the name column region 107. In response to the sub-level being collapsed, “expand all sub-levels” is displayed if the mouse hovers over the expand/collapse control. In response to the sub-level being expanded, “collapse all sub-levels” is displayed if the mouse hovers over the expand/collapse control. In response to the sub-level being expanded or collapsed, a corresponding Gantt bar is also expanded or collapsed.

In response to the view switching operation being performed, display information for the first view 106 may be determined based on a second filter condition input by the user. The second filter condition may comprise a node display range of an association node between the first work item and the association work item.

As shown in FIG. 2C, after the schedule management mode is triggered in the mode selection window 103, a setting control 104 of the node display range is displayed. The setting control 104 of the node display range is in an off state by default.

In response to the user triggering the setting control 104 of the node display range, as shown in FIG. 2D, a node display range setting window 105 may be displayed. The node display range of the association node between the first work item and the association work item may be set based on the node display range setting window 105.

In this embodiment, the node to which the sub-work item of the first work item and the sub-work item of the association work item belong may be displayed in the first view 106 by default. Also, based on the node display range set by the node display range setting window 105, the node set by hitting the display condition may be added.

In the node display range setting window 105, a hierarchical structure based on the node flow work item may be displayed on one side, which may be displayed as a [work item name] node, and an interface condition number display is provided. After the trigger, a display condition configuration panel corresponding to the work item node is provided, and configuration conditions such as a node name, a node state, a node estimate, a node schedule, a node leader, and whether the node schedule is required are provided.

For different configuration conditions, a logical operator, a filter value, a judgment basis, and the like for each configuration condition may be further provided. For example, for the node name, a logical operator, that is, include, exclude, equal, and not equal, may be provided, and a filter value, that is, all nodes under the work item, may be provided.

In this embodiment, in response to the association node between the first work item and the association work item is additionally set based on the node display range setting window 105, the node display of the association node and the second Gantt bar corresponding to the association node need to be added in the first view 106. The length of the second Gantt bar of the association node is determined based on the earliest start time and the latest end time of the association node. The display effect of the second Gantt bar of the association node is distinguished from the display effect of the Gantt chart of other work items. The node circle and the node name are displayed at the position where the node schedule start time is displayed on the second Gantt bar of the association node. Information such as a node identifier, a node leader, and a node estimate may be displayed in the second Gantt bar.

In this embodiment, the setting control 104 that displays the node display range is in an off state by default. In response to the setting control 104 being turned on, the display of the association node and the second Gantt bar may be added according to the range set in the node display range setting window 105. In response to the setting control 104 being turned off, the display of the association node and the second Gantt bar added according to the range set in the node display range setting window 105 is no longer displayed. The setting control 104 cannot be triggered, and prompt information “available after the switch is on” is displayed.

As shown in FIG. 2E, the display area of the information column region 108 and the display area of the view region 109 in the first view have a preset size or a preset ratio, for example, the information column region 108 and the view region 109 may each account for 50%.

As shown in FIG. 2E, the name column region 107 is frozen, that is, a size and/or a position of the name column region 107 cannot be adjusted, and the name column region 107 is usually displayed on the left of the first page. Even if the information column region 108 and the view region 109 are dragged, the position of the name column region 107 does not change.

In order to facilitate the user to view the display content of the information column region 108 and the view region 109, the user may drag the information column region 108 to adjust the display area of the information column region 108 and the display area of the view region 109. In response to the display area of the information column region 108 being increased, the display area of the view region 109 is reduced. In response to the display area of the information column region 108 being reduced, the display area of the view region 109 is increased, which is convenient for the user to view. In response to the user reducing the display area of the information column region 108 through the drag-and-drop operation, the information column region 108 may be completely hidden, which is not limited in this embodiment.

The view region 109 in the first view 106 may support a plurality of step sizes for display, for example, step sizes such as month, two months, quarter, half year, and year.

In response to the step size being switched from a small granularity to a large granularity, the column corresponding to the content in the first column of the current interface in a new step size is in the first column. For example, in response to the step size being switched from month to year, the first column is 3.12 before the switch, and the first column is March after the switch.

In response to the step size being switched from a large granularity to a small granularity, the column corresponding to a start date of the first column of the current interface in a new step size is in the first column. For example, In response to the step size being switched from year to month, the first column is March before the switch, and the first column is 3.1 after the switch.

As shown in FIG. 2F, the display information in the information column region 108 of the first view 106 may be inserted and deleted directly in the first view 106, that is, a field of a table column is inserted or deleted, so that the display information in the information column region 108 of the first view is different from the display information in the information column region of the second tree view, thereby fulfilling different viewing requirements of the user for data in two different views.

As shown in FIG. 2G, a configuration operation may also be performed on the first view through a preset configuration window 110, to configure the display field in the information column region 108 of the first view 106, so as to determine the display content in the information column region of the first view 106. The configuration window 110 also provides a configuration operation for the second tree view, which is not limited in this embodiment. In response to the user being in the second tree view mode, the configuration window 110 displays a configuration page for the second tree view by default. In response to the user being in a first view mode, the configuration window 110 displays a configuration page for the first view by default.

As shown in FIG. 2H, in response to the first work item, the association work item, or the association node has the scheduling capability but the scheduling operation being not currently performed, a scheduling operation entry may be displayed in the view region of the first view. For example, in response to the user hovering the mouse over a Gantt chart cell corresponding to each the first work item, the association work item, or the association node, the display of the scheduling operation entry 111 is triggered.

In some embodiments, in response to the scheduling operation entry 111 being displayed, prompt information of “create a new schedule” may be displayed, and the time axis corresponding to the Gantt chart cell is highlighted.

In response to the user triggering the scheduling operation entry 111, a Gantt bar may be drawn to implement the scheduling operation on the first work item, the association work item, or the association node.

For a work item instance such as the first work item, the association work item, or the association node without a scheduling capability, even if the user hovers the mouse over a Gantt chart cell corresponding to the first work item, the association work item, or the association node, the display of the scheduling operation entry is not triggered, and the first prompt information is also displayed at the same time. The first prompt information may be, for example, “[work item] scheduling capability is not currently enabled”, so that the user can be reminded that the first work item, the association work item, or the association node is not capable of scheduling, and the scheduling operation cannot be performed on the first work item, the association work item, or the association node.

It may be understood that before the technical solutions of the embodiments of the present disclosure are used, the user may be informed of the type, scope of use, use scenario, and the like of the involved personal information in an appropriate manner, and the authorization of the user may be obtained.

For example, in response to receiving an active request from the user, the user is sent prompt information to clearly inform the user that an operation requested by the user needs to obtains and use user's personal information. In this way, the user may independently select, based on the prompt information, whether to provide the personal information to software or hardware such as an electronic device, an application, a server, or a storage medium that performs the operation of the technical solutions of the present disclosure.

As an optional but non-limiting implementation, a mode of sending prompt information to the user in response to receiving the active request from the user may be, for example, a pop-up window, and the prompt information may be presented in the pop-up window in text. In addition, the pop-up window may further carry a selection control for the user to select “agree” or “disagree” to provide the personal information to the electronic device.

It may be understood that the above process of notifying and obtaining the user's authorization is only illustrative, and does not limit the implementations of the present disclosure. Other manners that meet relevant laws and regulations may also be applied to the implementations of the present disclosure.

It should be noted that the method of the embodiments of the present disclosure may be executed by a single device, such as a computer or a server. The method of the embodiments may also be applied to a distributed scenario, and a plurality of devices may cooperate with each other to complete the method. In response to such a distributed scenario, one device of the plurality of devices may only execute a certain one or a plurality of steps in the method of the embodiments of the present disclosure, and the plurality of devices may interact with each other to complete the method.

It should be noted that some embodiments of the present disclosure are described above. Other embodiments are within the scope of the appended claims. In some cases, the acts or steps recited in the claims may be performed in an order different from that in the above embodiments, and the desired results may still be achieved. In addition, the processes depicted in the drawings do not necessarily require the specific order shown or the continuous order to achieve the desired results. In some implementations, multitasking and parallel processing are also possible or may be advantageous.

Based on the same inventive concept, corresponding to any of the above embodiments, the present disclosure further provides an information processing apparatus.

Referring to FIG. 3, the apparatus comprises:
an obtaining module 11 configured to obtain a first operation on a first work item in a first system; and
a display module 13 configured to display a first view, wherein the first view comprises a first tree view and a Gantt chart; wherein the first tree view is configured to display at least part of work item association information for the first work item and an association work item of the first work item, and the Gantt chart is configured to display scheduling information for the first work item and the association work item of the first work item.

In some embodiments, in the first view:
the first tree view and the Gantt chart share a name list of the first work item and the association work item of the first work item; and
for a name item in the name list, work item association information corresponding to the name item in the first tree view and scheduling information corresponding to the name item in the Gantt chart are displayed in a same row.

In some embodiments, the association work item is determined based on a pre-configured first filter condition, and the apparatus is further configured to:
obtaining a second filter condition input by a user and determining the scheduling information for the Gantt chart based on the first filter condition and the second filter condition.

In some embodiments, the second filter condition comprises a node display range of an association node between the first work item and the association work item;

the display module 13 is further configured to:
display a first Gantt bar corresponding to the first work item and the association work item in the Gantt chart; and
display the association node between the first work item and the association work item, and a second Gantt bar corresponding to the association node in the Gantt chart, wherein a length of the second Gantt bar is determined based on a start time and an end time of the association node.

In some embodiments, the apparatus is further configured to switch between displaying the first view and a second tree view in response to a view switching operation on the first work item,

wherein view content of the second tree view is the same as view content of the first tree view in the first view.

In some embodiments, the apparatus is further configured to:
display a view switching entry in response to the first work item meeting a first preset condition, wherein the view switching entry is configured to implement the view switching operation.

In some embodiments, the second information comprises scheduling information, and the first work item meeting the first preset condition comprises:
the first work item being a first-type work item, wherein the first-type work item is capable of scheduling; or
the first work item being a second-type work item, and the first work item being configured to be capable of scheduling.

In some embodiments, the first work item is a second-type work item, and the first work item is configured to be capable of scheduling, and the apparatus is further configured to:
cancel displaying the view switching entry and switching the first view to the second tree view in response to modifying the first work item to be capable of scheduling.

In some embodiments, the view switching operation is performed by a first user, and the apparatus is further configured to:
determine, based on an operation permission of the first user on the first work item, whether the first view is displayed on a client corresponding to another user of the first work item.

In some embodiments, the first view comprises:
a name column region configured to display a name of the first work item and a name of the association work item of the first work item;
an information column region configured to display the at least part of the work item association information in the first tree view; and
a view region configured to display the scheduling information in the Gantt chart.

In some embodiments, the apparatus is further configured to:
increase a display area of the information column region and reducing a display area of the view region, or reducing the display area of the information column region and increasing the display area of the view region in response to a drag-and-drop operation on the information column region.

In some embodiments, the apparatus is further configured to:
increase display information in the information column region in response to a column insert operation on the information column region; or
reduce the display information in the information column region in response to a column delete operation on the information column region.

In some embodiments, the apparatus is further configured to:
configure a display field in the information column region in response to a configuration operation on the first view.

In some embodiments, the apparatus is further configured to:
display a scheduling operation entry in the view region, in response to at least one of the first work item, the association work item, or an association node between the first work item in the first view being capable of scheduling and not performing a scheduling operation; and
perform the scheduling operation on the at least one of the first work item, the association work item, or the association node between the first work item and the association work item in response to a Gantt bar draw operation based on the scheduling operation entry.

In some embodiments, the apparatus is further configured to:
display first prompt information, in response to at least one of the first work item, the association work item, or an association node between the first work item and the association work item in the first view being not capable of scheduling, wherein the first prompt information is configured to prompt that the at least one of the first work item, the association work item, or the association node between the first work item and the association work item is not configured to be capable of performing a scheduling operation.

For the convenience of description, the above apparatus is described in various modules according to functions. Certainly, in the implementation of the present disclosure, the functions of the modules may be implemented in one or more pieces of software and/or hardware.

The apparatus of the above embodiments is used for implementing the corresponding information processing method in any of the above embodiments, and has beneficial effects of the corresponding method embodiments, which are not repeated herein.

Based on the same inventive concept, corresponding to any of the above embodiments, the present disclosure further provides an electronic device. The electronic device comprises a memory, a processor, and a computer program stored on the memory and able to run on the processor, wherein the processor, when executing the program, implements an information processing method according to any of the above embodiments.

FIG. 4 shows a schematic diagram of a more specific hardware structure of an electronic device provided in this embodiment. The device may comprise a processor 1010, a memory 1020, an input/output interface 1030, a communication interface 1040, and a bus 1050. The processor 1010, the memory 1020, the input/output interface 1030, and the communication interface 1040 implement communication connection between each other inside the device through the bus 1050.

The processor 1010 may be implemented by using a general-purpose CPU(Central Processing Unit), a microprocessor, an ASIC(Application Specific Integrated Circuit), or one or more integrated circuits, and is used for executing relevant programs to implement the technical solutions provided in the embodiments of the present description.

The memory 1020 may be implemented in the form of a ROM(Read Only Memory), a RAM(Random Access Memory), a static storage device, a dynamic storage device, or the like. The memory 1020 may store an operating system and other application programs. When the technical solutions provided in the embodiments of the present description are implemented through software or firmware, the related program codes are stored in the memory 1020 and invoked by the processor 1010 for execution.

The input/output interface 1030 is configured to connect to an input/output module to implement information input and output. The input/output module may be configured in the device as a component (not shown in the figure), or may be externally connected to the device to provide corresponding functions. The input device may comprise a keyboard, a mouse, a touchscreen, a microphone, various sensors, and the like. The output device may comprise a display, a speaker, a vibrator, an indicator light, and the like.

The communication interface 1040 is configured to connect to a communication module (not shown in the figure) to implement communication interaction between the device and other devices. The communication module may implement communication through a wired manner (for example, a USB, a network cable, or the like), or may implement communication through a wireless manner (for example, a mobile network, WIFI, Bluetooth, or the like).

The bus 1050 comprises a path for transmitting information between components (for example, the processor 1010, the memory 1020, the input/output interface 1030, and the communication interface 1040) of the device.

It should be noted that although the above device only shows the processor 1010, the memory 1020, the input/output interface 1030, the communication interface 1040, and the bus 1050, in a specific implementation process, the device may further comprise other components necessary for normal operation. In addition, those skilled in the art may understand that the above device may also comprise only components necessary for implementing the solutions of the embodiments of the present description, without comprising all the components shown in the figure.

The electronic device of the above embodiments is used for implementing the corresponding information processing method in any of the above embodiments, and has beneficial effects of the corresponding method embodiments, which are not repeated herein.

Based on the same inventive concept, corresponding to any one of the above embodiments, the present disclosure further provides a non-transitory computer-readable storage medium storing computer instructions, wherein the computer instructions are configured to cause the computer to execute an information processing method according to any one of the above embodiments.

The computer-readable medium of this embodiment comprises permanent and non-permanent, removable and non-removable media, and information storage may be implemented by any method or technology. The information may be computer-readable instructions, data structures, program modules, or other data. Examples of computer storage media comprise, but are not limited to, PRAM(phase-change memory), SRAM(static random-access memory), DRAM(dynamic random-access memory), other types of RAM(random-access memory), ROM(read-only memory), EEPROM(electrically erasable programmable read-only memory), flash memory or other memory technology, CD-ROM(compact disc read-only memory), DVD(digital versatile disc) or other optical storage, magnetic cassette, magnetic tape, magnetic disk storage, or other magnetic storage device, or any other non-transmission medium that may be used for storing information accessible by a computing device.

The computer instructions stored in the storage medium of the above embodiments are used for causing the computer to execute the method according to any one of the above embodiments, and have beneficial effects of the corresponding method embodiments, which are not repeated herein.

Based on the same inventive concept, corresponding to any one of the above embodiments, the present disclosure further provides a computer program product comprising computer program. In some embodiments, the computer program is executable by one or a plurality of processors, so that the processor executes the information processing method. Corresponding to the execution subject corresponding to each step in each embodiment of the method, the processor that executes the corresponding step may belong to the corresponding execution subject.

The computer program product of the above embodiments is used for causing the processor to execute the information processing method according to any of the above embodiments, and has beneficial effects of the corresponding method embodiments, which are not repeated herein.

It should be understood by those of ordinary skill in the art that discussion of any of the above embodiments is merely exemplary, and is not intended to suggest that the scope of the present disclosure (comprising the claims) is limited to these examples. Under the inventive concept of the present disclosure, the technical features in the above embodiments or different embodiments may be combined, and the steps may be implemented in any order. There are many other changes in different aspects of the embodiments of the present disclosure as described above, which are not provided in detail for the sake of brevity.

In addition, in order to simplify the description and discussion, and in order not to make the embodiments of the present disclosure difficult to understand, the well-known power/ground connection with the IC(integrated circuit) chip and other components may or may not be shown in the drawings provided. In addition, the apparatus may be shown in the form of a block diagram, so as to avoid making the embodiments of the present disclosure difficult to understand. This also takes into account the fact that the details of the implementations of these block diagram apparatuses are highly dependent on the platform on which the embodiments of the present disclosure are to be implemented (that is, the details should be completely within the understanding of those of ordinary skill in the art). In the case where specific details (for example, circuits) are set forth to describe exemplary embodiments of the present disclosure, it is obvious to those of ordinary skill in the art that the embodiments of the present disclosure may be implemented without these specific details or with changes in these specific details. Therefore, these descriptions should be considered as illustrative rather than restrictive.

Although the present disclosure has been described in combination with specific embodiments of the present disclosure, many alternatives, modifications, and variations of these embodiments will be obvious to those of ordinary skill in the art according to the foregoing description. For example, other memory architectures (for example, dynamic RAM (DRAM)) may use the discussed embodiments.

The embodiments of the present disclosure are intended to cover all such alternatives, modifications, and variations that fall within the broad scope of the appended claims. Therefore, any omission, modification, equivalent replacement, improvement, etc. made within the spirit and principles of the embodiments of the present disclosure shall be comprised in the protection scope of the present disclosure.

What is claimed is:

1. An information processing method, comprising:
obtaining a first operation on a first work item in a first system; and
displaying a first view, wherein the first view comprises a first tree view and a Gantt chart,
wherein the first tree view is configured to display at least part of work item association information of the first work item and an association work item of the first work item, and the Gantt chart is configured to display scheduling information of the first work item and the association work item of the first work item.

2. The method according to claim 1, wherein in the first view:
the first tree view and the Gantt chart share a name list of the first work item and the association work item of the first work item; and
for a name item in the name list, work item association information corresponding to the name item in the first tree view and scheduling information corresponding to the name item in the Gantt chart are displayed in a same row.

3. The method according to claim 1, further comprises:
obtaining a second filter condition input by a user and determining the scheduling information of the Gantt chart based on the first filter condition and the second filter condition, wherein the association work item is determined based on a pre-configured first filter condition.

4. The method according to claim 3, wherein the second filter condition comprises a node display range of an association node between the first work item and the association work item;
the method further comprises:
displaying a first Gantt bar corresponding to the first work item and the association work item in the Gantt chart; and
displaying the association node between the first work item and the association work item, and a second Gantt bar corresponding to the association node, wherein a length of the second Gantt bar is determined based on a start time and an end time of the association node.

5. The method according to claim 1, further comprising:
switching between displaying the first view and a second tree view in response to a view switching operation on the first work item; and
wherein view content of the second tree view is the same as view content of the first tree view in the first view.

6. The method according to claim 5, further comprising:
displaying a view switching entry in response to the first work item meeting a first preset condition, wherein the view switching entry is configured to implement the view switching operation.

7. The method according to claim 6, wherein the first work item meeting the first preset condition comprises:
the first work item being a first-type work item, wherein the first-type work item is capable of scheduling; or
the first work item being a second-type work item, and the first work item being configured to be capable of scheduling.

8. The method according to claim 6, wherein the first work item is a second-type work item, and the first work item is configured to be capable of scheduling; after the displaying the first view, the method further comprises:
canceling displaying the view switching entry and switching the first view to the second tree view in response to modifying the first work item to be capable of scheduling.

9. The method according to claim 5, wherein the view switching operation is performed by a first user, the method further comprises:
determining, based on an operation permission of the first user on the first work item, whether the first view is displayed on a client corresponding to another user of the first work item.

10. The method according to claim 1, wherein the first view comprises:
a name column region configured to display a name of the first work item and a name of the association work item of the first work item;
an information column region configured to display the at least part of the work item association information in the first tree view; and
a view region configured to display the scheduling information in the Gantt chart.

11. The method according to claim 10, further comprising:
increasing a display area of the information column region and reducing a display area of the view region, or reducing the display area of the information column region and increasing the display area of the view region in response to a drag-and-drop operation on the information column region.

12. The method according to claim 10, further comprising:
increasing display information in the information column region in response to a column insert operation on the information column region; or
reducing the display information in the information column region in response to a column delete operation on the information column region.

13. The method according to claim 10, further comprising:
configuring a display field in the information column region in response to a configure operation on the first view.

14. The method according to claim 10, further comprising:
displaying a scheduling operation entry in the view area, in response to at least one of the first work item, the association work item, or an association node between the first work item in the first view being capable of scheduling and not performing a scheduling operation; and
performing the scheduling operation on the at least one of the first work item, the association work item, or the association node between the first work item and the association work item in response to a Gantt bar draw operation based on the scheduling operation entry.

15. The method according to claim 10, further comprising:
displaying first prompt information, in response to at least one of the first work item, the association work item, or an association node between the first work item and the association work item in the first view being not capable of scheduling, wherein the first prompt information is configured to prompt that the at least one of the first work item, the association work item, or the association node between the first work item and the association work item is not configured to be capable of performing a scheduling operation.

16. An electronic device, comprising a memory, a processor, and a computer program stored on the memory and able to run on the processor, wherein the processor, when executing the program, implements an information processing method, comprising:
obtaining a first operation on a first work item in a first system; and
displaying a first view, wherein the first view comprises a first tree view and a Gantt chart,
wherein the first tree view is configured to display at least part of work item association information of the first work item and an association work item of the first work item, and the Gantt chart is configured to display scheduling information of the first work item and the association work item of the first work item.

17. The electronic device according to claim 16, wherein in the first view:
the first tree view and the Gantt chart share a name list of the first work item and the association work item of the first work item; and
for a name item in the name list, work item association information corresponding to the name item in the first tree view and scheduling information corresponding to the name item in the Gantt chart are displayed in a same row.

18. The electronic device according to claim 16, wherein the processor implements a following step:
obtaining a second filter condition input by a user and determining the scheduling information of the Gantt chart based on the first filter condition and the second filter condition, wherein the association work item is determined based on a pre-configured first filter condition.

19. The electronic device according to claim 18, wherein the second filter condition comprises a node display range of an association node between the first work item and the association work item,
the processor implements following steps:
displaying a first Gantt bar corresponding to the first work item and the association work item in the Gantt chart; and
displaying the association node between the first work item and the association work item, and a second Gantt bar corresponding to the association node, wherein a length of the second Gantt bar is determined based on a start time and an end time of the association node.

20. A non-transitory computer-readable storage medium, storing computer instructions, wherein the computer instructions are used for causing the computer to execute an information processing method, comprising:
obtaining a first operation on a first work item in a first system; and
displaying a first view, wherein the first view comprises a first tree view and a Gantt chart,
wherein the first tree view is configured to display at least part of work item association information of the first work item and an association work item of the first work item, and the Gantt chart is configured to display scheduling information of the first work item and the association work item of the first work item.
